(19) United States
(12) Patent Application Publication
(10) Pub. No.: US 2013/0188212 A1
(43) Pub. Date: Jul. 25, 2013

(54) Data Server, Network System, and Upload Method

(71) Applicants: Salil Pardhan, San Jose, CA (US); Gary Marsh, Rutherford, NJ (US); Ichiro Sasaki, Aichi-ken (JP); Kunihiro Yasui, Nagoya-shi (JP); Takafumi Mori, Nagoya-shi (JP)

(72) Inventors: Salil Pardhan, San Jose, CA (US); Gary Marsh, Rutherford, NJ (US); Ichiro Sasaki, Aichi-ken (JP); Kunihiro Yasui, Nagoya-shi (JP); Takafumi Mori, Nagoya-shi (JP)

(21) Appl. No.: 13/356,554

(22) Filed: Jan. 23, 2012

(51) Int. Cl. G06K 15/02; G06F 3/12

(52) U.S. Cl. 358/1.14; 358/1.15

(57) ABSTRACT

A data server is connected to an image scanning device via a network. The data server performs the steps of: acquiring location information indicating a location of a service providing device in the network. The service providing device is operated in the network via a web page and the web page includes operating information for instructing the image scanning device to execute a scanning process. The data server also performs the steps of determining an image scanning device to which an operation signal for executing an image scanning process is transmitted, transmitting the operation signal to the determined image scanning device to cause the determined image scanning device to execute an image scanning process, storing scanned data obtained from the image scanning process, and instructing the service providing device indicated by the acquired location information to acquire the scanned data.

### BACKGROUND OF THE DISCLOSURE

1. Field of the Invention

The present invention relates generally to a data server. Specifically, the invention relates to a method of uploading data to a web site in a network, in response to operation information operated on the web site.

2. Related Art

When transmission and reception of a significant volume of data is implemented using a network, various kinds of data are uploaded to various web services. For example, an image is scanned by an image scanner device, e.g., a scanner, and is converted into image data. The converted data are uploaded to a storage device in a network from the image scanner device or from a computer connected to the image scanner device. The data uploaded to the storage device are set to be utilized by a user via a web service.

In a known method, a user executes an application to operate the image scanner device when uploading image data to a web service. Specifically, the user operates the image scanner device by executing a scanner application different from the web service. Image data are acquired by the image scanner device scanning an image using the scanner application.

### SUMMARY OF THE INVENTION

In order to use the scanned image data in a web service, the use uploads the image data to the web. The user specifies a web service, to which the image data are to be uploaded, by operating the image scanner device or a computer connected to the image scanner device. The image data then are uploaded to the specified web service by the user operating the image scanner device or the computer. Thus, when uploading data to a network service to be utilized, the user starts up a scanner application different from the network service, such that the user executes a plurality of procedures for uploading, which is inconvenient for the user.

A need has arisen for a data server, a network system, and an upload method, with which data are automatically uploaded to a web site by an image scanner device connected to a network, in response to operation information operated in a web service.

According to an embodiment of the present invention, a data server is configured to be connectable to an image scanning device via a network, the data server processing device comprising: a processor having computer readable instruction stored thereon and configured to control the data server to execute steps of: acquiring location information indicating a location of a service providing device in the network, wherein the service providing device is configured to be operated in the network via a web page and the web page comprises operating information for instructing the image scanning device to execute a scanning process; determining an image scanning device to which an operation signal for executing an image scanning process is transmitted in response to operation of the operating information in the web page; transmitting the operation signal to the determined image scanning device via the network to cause the determined image scanning device to execute an image scanning process; storing scanned data obtained from the image scanning process of the determined image scanning device in a memory; and instructing the service providing device indicated by the acquired location information to acquire the scanned data stored in the memory.

According to another embodiment of the present invention, a network system is configured to be connectable to a data server and an image scanning device configured to scan an image, the data server comprising: a first processor having computer readable instructions stored thereon and configured to control the data server to execute the steps of: acquiring location information indicating a location of a service providing device in the network system, wherein the service providing device is configured to be operated in the network system via a web page and the web page comprises operating information for instructing the image scanning device to execute a scanning process; determining an image scanning device to which an operation signal for executing an image scanning process is transmitted in response to operation of the operating information in the web page; transmitting the operation signal to the determined image scanning device via the network system to cause the determined image scanning device to execute an image scanning process; storing scanned data obtained from the image scanning process of the determined image scanning device in a memory; instructing the service providing device indicated by the acquired location information to acquire the scanned data stored in the memory, wherein the image scanning device comprising: a second processor having computer readable instructions stored thereon and configured to control the image scanning device to execute steps of: receiving the operation signal; executing the scanning process in response to receiving the operation signal; and uploading the scanned data to the data server or the service providing device.

According to still another embodiment of the present invention, an upload method for a network system configured to be connectable to a data server, an image scanning device configured to scan an image, and a managing device that configured to receive a web page, the upload method comprising the steps of: operating the image scanning device to execute a scanning process by operating operation information displayed on the web page received at the managing device in the network system; acquiring location information indicating a location of a service providing device in the network system, wherein the service providing device is configured to be operated in the network system via the web page comprising the operating information; determining an image scanning device to which an operation signal for executing the image scanning process is to be transmitted in response to operation of the operating information in the web page; transmitting the operation signal from the data server to the determined image scanning device; receiving the operation signal at the image scanning device; executing the scanning process at the image scanning device in response to receiving the operation signal; uploading scanned data from the image scanning device to the data server or the service providing device; storing the scanned data in a memory at the data server; and controlling the service providing device indicated by the acquired location information to acquire the scanned data stored in the memory at the data server.

Other objects, features, and advantages of an embodiment of the invention will be apparent to persons of ordinary skill in the art from the following description of an embodiment with reference to the accompanying drawings

### BRIEF DESCRIPTION OF THE DRAWINGS

For a more complete understanding of the present invention, needs satisfied thereby, and the objects, features, and advantages thereof, reference now is made to the following descriptions taken in connection with the accompanying drawings.

FIG. 1 is a configuration diagram of a network system according to a first embodiment of the invention.

FIG. 2 is a diagram depicting a process of operating a scanner device from a network service according to the first embodiment of the invention.

FIG. 3 is a diagram of a scan icon displayed on a web page provided by an external server according to the first embodiment of the invention.

FIG. 4 is a diagram depicting a method in which image data scanned by a scanner device are browsed by an information processing device via a network service according to the first embodiment of the invention.

FIG. 5 is a diagram depicting an electrical configuration of a central server according to the first embodiment of the invention.

FIG. 6 is a diagram depicting an electrical configuration of a scanner device according to the first embodiment of the invention.

FIG. 7 is a flowchart depicting a main process of the central server according to the first embodiment of the invention.

FIG. 8 is another flowchart depicting the main process of the central server according to the first embodiment of the invention.

FIG. 9 is a flowchart depicting a main process of an external server according to the first embodiment of the invention.

FIG. 10 is another flowchart depicting the main process of the external server according to the first embodiment of the invention.

FIG. 11 is a flowchart depicting a main process of a scanner device according to the first embodiment of the invention;

FIG. 12 is a flowchart depicting a main process of the central server according to a second embodiment of the invention.

FIG. 13 is another flowchart depicting the main process of the central server according to the second embodiment of the invention.

FIG. 14 is still another flowchart depicting the main process of the central server CS according to the first embodiment of the invention.

FIG. 15 is flow chart depicting a main process of an external server according to the second embodiment of the invention.

### DETAILED DESCRIPTION OF EMBODIMENTS OF THE INVENTION

For a more complete understanding of the present invention, needs satisfied thereby, and the objects, features, and advantages thereof, reference now is made to the following description taken in connection with the accompanying drawings.

### 1. Configuration of Network System S

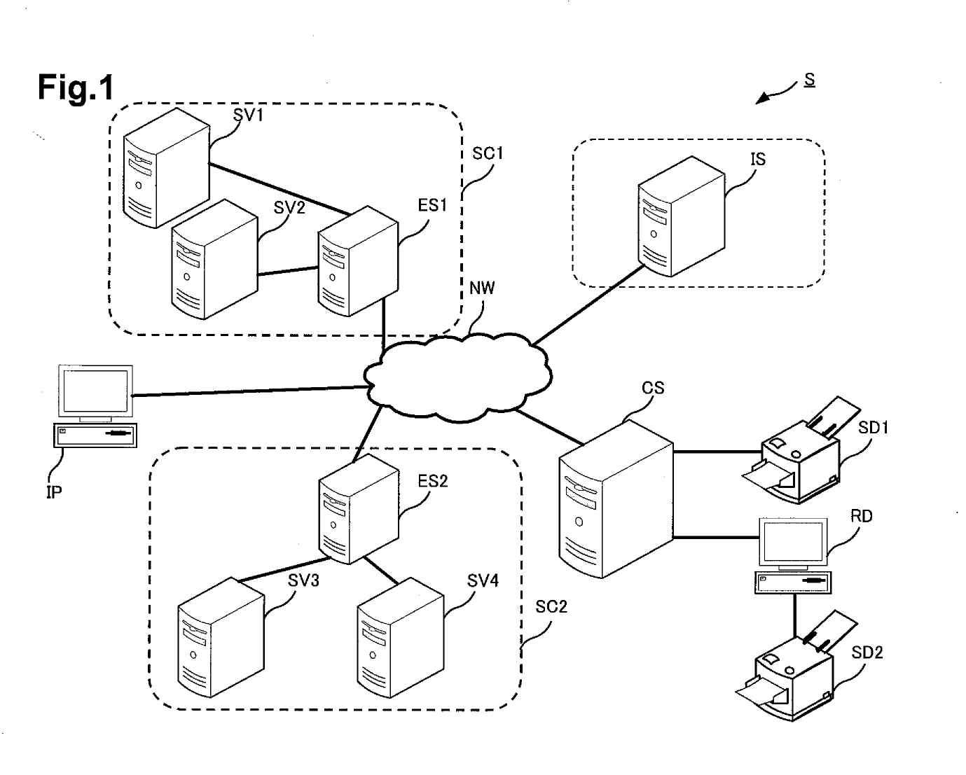

As shown in FIG. 1, the network system S may comprise a central server CS. The network system S may further comprise a first scanner device SD1, a second scanner device SD2, and a relay device RD. The first scanner device SD1 may be connected directly to the central server CS, without a relay device. The second scanner device SD2 may be connected to the central server CS via the relay device RD. The relay device RD may comprise a general personal computer. Also, the first scanner device SD1 and second scanner device SD2 may be devices that are configured to scan an image. In another example, the first scanner device SD1 or second scanner device SD2 may comprise printing devices that include a scanner function.

The network system S may comprise an internal server IS. The internal server IS may be a server device provided by the manufacturer of manufacturers of the first scanner device SD1 and second scanner device SD2. The first scanner device SD1 and second scanner device SD2 may upload document data to the internal server IS by accessing the internal server IS.

The network system S may comprise a first network service SC1 and a second network service SC2. The first network service SC1 may comprise an external server ES1. The second network service SC2 may comprise an external server ES2.

The external server ES1 may provide the first network service SC1 from a company different from the manufacturer or manufacturers of the scanner devices. The external server ES2 may provide the second network service SC2 from a company different from the manufacturer or manufacturers of the scanner devices and from the company of the external server ES1. The external server ES1 and external server ES2 may be server devices managed by different companies that provide services via a network NW. The external server ES1 and external server ES2 may be web servers used for providing services.

The first network service SC1 may comprise a first storage server SV1 and a second storage server SV1. The second network service SC2 may comprise a third third storage server SV3 and a fourth storage server SV4. In another embodiment, the external server ES1 or external server ES2 may comprise a storage area for data utilized in a network service, instead of storage servers.

The network system S may comprise an information processing device IP. The information processing device IP may utilize services provided by the first network service SC1 and second network service SC2. Specifically, the information processing device IP may acquire a web page information from the external server ES1 or external server ES2, and utilize the first network service SC1 and second network service SC2. The information processing device IP may utilize data stored in the storage servers SV1, SV2, SV3, and SV4 via the first network service SC1 and second network service SC2, respectively.

The information processing device IP may utilize a service provided by the internal server IS. In one embodiment, the information processing device IP may be a general personal computer. In another embodiment, the information processing device IP may be a portable terminal device, e.g., a smartphone or the like. The information processing device IP may be a device that processes information. As shown in FIG. 1, the central server CS, first scanner device SD1, relay device RD, information processing device IP, internal server IS, external server ES1, and external server ES2 may communicate with each other via the network NW.

### 2. Processes of Network System S

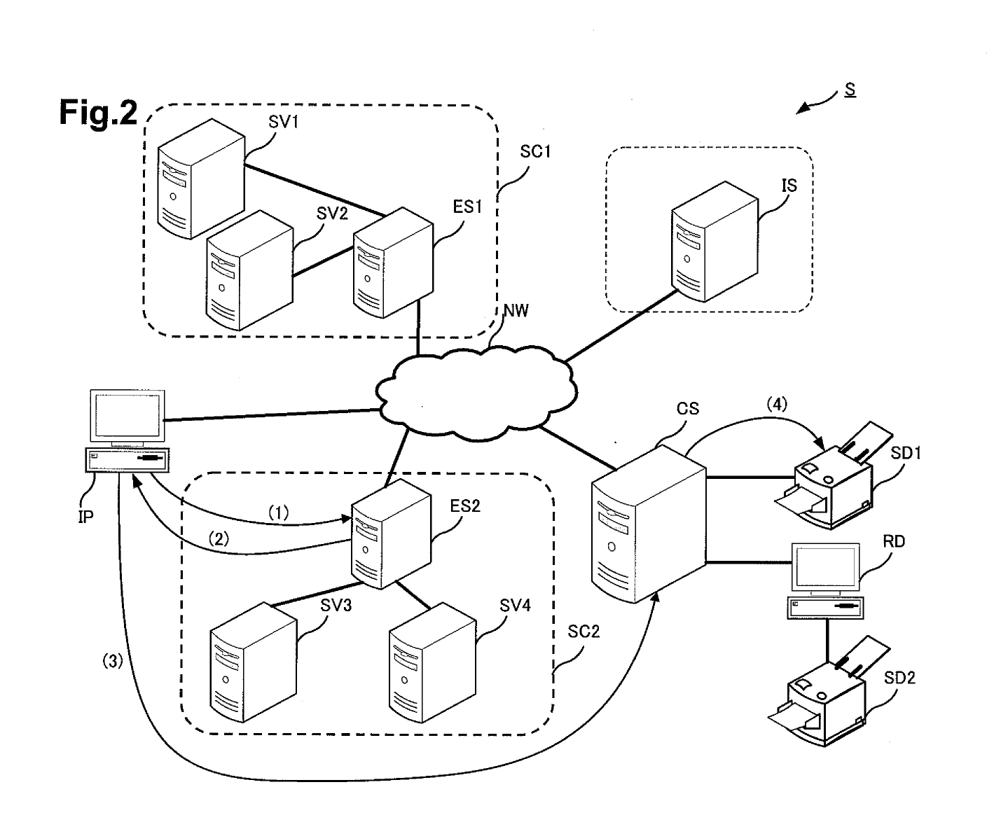

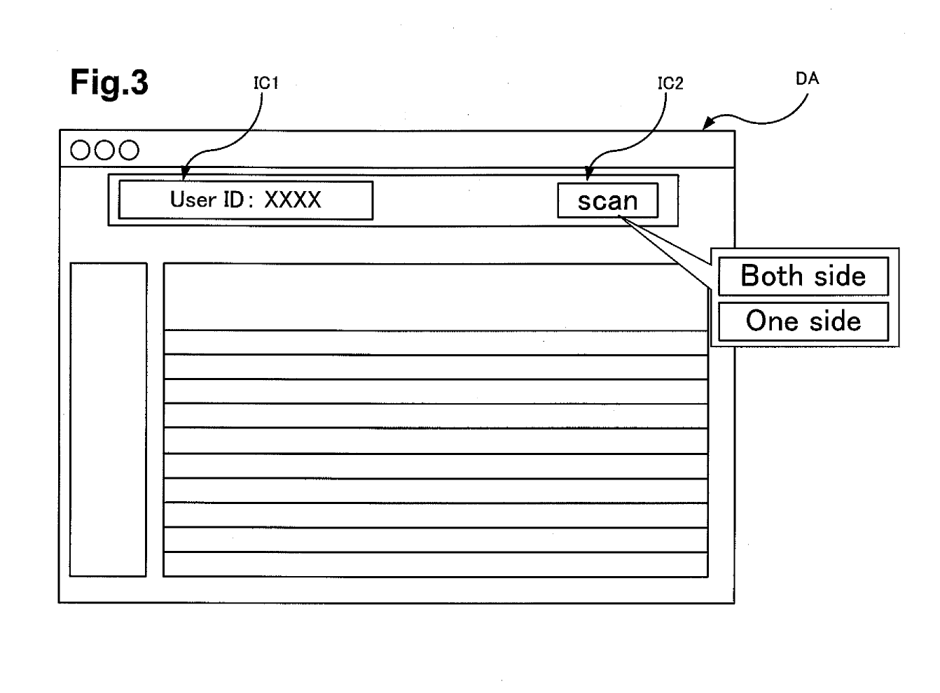

As shown in FIG. 2, the information processing device IP may accesses the external server ES2, e.g., arrow (1) in FIG. 2. The information processing device IP may acquire a web page from the external server ES2, e.g., arrow (2) in FIG. 2. A web page provided by the external server ES2 may be acquired by the information processing device IP. The acquired web page may enable the information processing device IP to use the second network service SC2. As shown in FIG. 3, the acquired web page may be displayed by a display unit controlled by the information processing device IP. A log-in process may be executed to grant access to the second network service SC2.

In a first embodiment, a web page including a user ID icon IC1 and a scan icon IC2 may be displayed on the display screen DA. The user ID may indicate an ID of a user logged in to the first network service SC1 or second network service SC2. The user ID input when executing the log-in process may be displayed in the user ID icon IC1. The scan icon IC2 may be operated by a user of the information processing device IP. The scan icon IC2 may be set to images for two-side scanning mode, one-side scanning mode, or the like, when the user operates the scan icon IC2. As shown in FIG. 3, a drop box containing selections for the both-side scanning mode and the one-side scanning mode may be displayed in response to an operation of the scan icon IC2. One of the both-side scanning mode and the one-side scanning mode may be selected from the drop box. A secure scanning mode also may be selected from the drop box. In the secure scanning mode, data scanned by the first scanner device SD1 or the second scanner device SD2 may be transmitted to the central server CS and to the external server ES2 via secured transmission route. For example, when a medical document is scanned by the first scanner device SD1 or SD2, the secure scanning mode may be selected, and the scanned medical document data may be transmitted to the central server CS and to the external server ES2 via the secured transmission route. The secure transmission route may comprise Hypertext Transfer Protocol Secure (HTTPS) communication. Furthermore, scan parameter or the like, of scanned image data may be settable when operating the scan icon IC2. The scan parameter may comprise one or more types of scan tray, color mode, resolution, document size, and duplex scan. The type of scan tray may include flat bed scanner or auto document feeder. The color mode may include mono color scan or gray scale scan or color scan. The document size may include A4 size or Letter size or Legal size.

An operation command may be transmitted from the information processing device IP to the central server CS in response to an operation of the scan icon IC2, e.g., arrow (3) in FIG. 2. The operation command may cause a scanner device utilizable by the information processing device IP to execute a scanning operation in response to the operation of the scan icon IC2. Before transmitting the operating command toward the central server CS, a login process to access the central server CS may be executed by the information processing device IP. A scanner device, to which the operation command is to be transmitted, may be selected in response to the operation of the scan icon IC2. The information processing device IP may utilize a plurality of devices in the network NW. By selecting the device to which the operation command is to be transmitted, the operation command may be transmitted to a scanner device desired by the user of the information processing device IP. In another embodiment, the device to which the operation command is to be transmitted may be automatically determined based on the logged-in user ID. The operation command may be transmitted automatically to the device determined based on the logged-in user ID. The operation command may comprise the scan parameter. The scan icon IC2 may be generated by the Hypertext Markup Language (HTML) inline frame code of the web page. When the user presses the scan icon IC2 on the external web page for the first time, an in-line frame may pop up requesting central server CS credentials.

In response to the selection of the device to which the operation command is to be transmitted by the information processing device IP, the operation command and device information may be transmitted, e.g., arrow (3) in FIG. 2. The device information may indicate that the device to which the operation command is to be transmitted have been identified. When the device, to which the operation command is to be transmitted, is determined automatically, the operation command and the logged-in user ID may be transmitted to the central server CS, e.g., arrow (3) in FIG. 2. In another embodiment, the operation command may be transmitted from the information processing device IP to the external server ES2 in response to an operation of the scan icon IC2. In response to receiving the operation command, the external server ES2 may transmit the operation command to the central server CS.

In response to receiving the operation command, the central server CS, in response to receiving the operation command, may determine the device based on the received device information. A shown in FIG. 2, the first scanner device SD1 may be identified based on the received device information. The central server CS then may transmit the operation command to the identified first scanner device SD1, e.g., arrow (4) in FIG. 2. When the device is determined automatically based on the user ID, the central server CS may identify the device based on the received user ID. As shown in FIG. 2, the first scanner device SD1 may be identified based on the received user ID. The central server CS then may transmit an operation command to the identified first scanner device SD1, e.g., arrow (4) in FIG. 2.

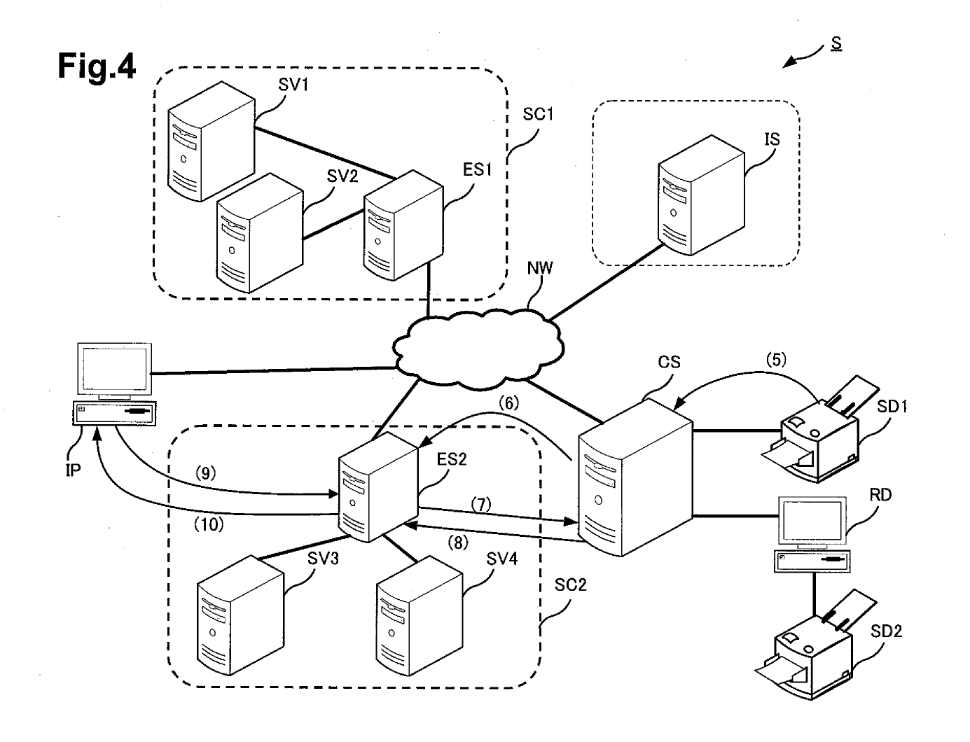

As shown in FIG. 4, the first scanner device SD1, in response to receiving the operation command, may execute an image scanning process. The first scanner device SD1 may then upload the scanned image data to the central server CS, e.g., arrow (5) in FIG. 4. When the second scanner device SD2 is identified, the operation command may be transmitted from the central server CS to the relay device RD. In response to receiving the operation command, the relay device RD may forward the operation command to the scanner device SC2, which is connected to the relay device RD. In response to receiving the operation command, the second scanner device SD2 may executes an image scanning process. The scanned image data may then be uploaded to the central server CS via the relay device RD. If a plurality of papers or documents is set on the first scanner device SD1 or the second scanner device SD2, the first scanner device SD1 or the second scanner device SD2 may scan image data for each paper or document. The first scanner device SD1 or the second scanner device SD2 may scan image data one page at a time. The scanned image data may be uploaded to the central server CS by the first scanner device SD1 or relay device RD one page at a time. After a plurality of papers or documents which is set on the first scanner device SD1 or the second scanner device SD2 has been scanned by the first scanner device SD1 or the second scanner device SD2, the scanned image data may be uploaded to the central server CS by the first scanner device SD1 or relay device RD. The central server CS may transmit the uploaded image data to the external server ES2 in response to receiving the uploaded image data from the first scanner device SD1 or relay device RD. The image data uploaded one page at a time may be integrated by the central server CS or the external server ES2.

When the image data is completely uploaded, the central server CS may transmit an upload completion command to the external server ES2, e.g., arrow (6) in FIG. 4. In response to receiving the upload completion command, the external server ES2 may download the uploaded image data from the central server CS, e.g., arrow (7) in FIG. 4. In the first embodiment, the external server ES2 may download the image data from the central server CS. When storage servers are included in the second network service SC2, the external server ES2 may transmit the downloaded image data to the third storage server SV3 or to fourth storage server SV4. In another embodiment, the central server CS may upload the image data to the external server ES2. The fourth storage server SV4 may download the image data uploaded from the central server CS. The downloaded image data may be stored in a predetermined storage area accessible using the logged-in user ID of the second network service SC2.

The information processing device IP may request the image data, which have become utilizable by the second network service SC2, using a web browser of information processing device IP, e.g., arrow (9) in FIG. 4. In response to receiving the request for the image data, the external server ES2 may transmit the web page. The transmitted web page may cause the information processing device IP to access the image data stored in the external server ES2, third storage server SV3, or fourth storage server SV4. The information processing device IP may be the source of the request. The information processing device IP may download the image data from the external server ES2, third storage server SV3, or fourth storage server SV4, in which the requested image data are stored, e.g., arrow (10) in FIG. 4.

The information processing device IP may remotely operate a scanner device via a web page provided by a network service. By commanding a scanning process on the web page, the information processing device IP may operate the scanner device to scan image data, and the scanned data may automatically be uploaded to a storage area of a network service usable by the information processing device IP.

### 3. Electrical Configuration of Central Server CS

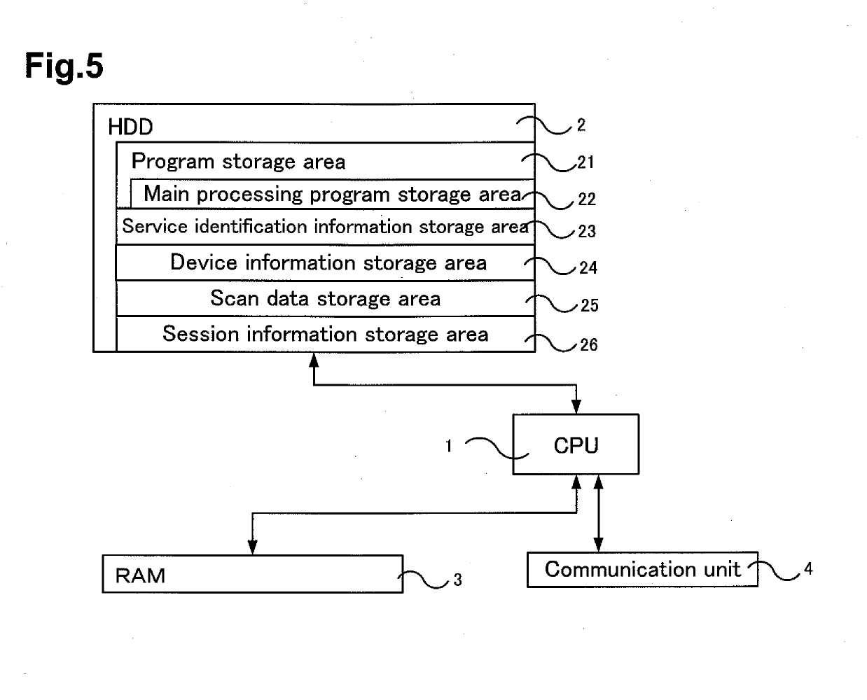

Referring to FIG. 5, an electrical configuration of the central server CS is depicted. The central server CS may comprise a Central Processing Unit (CPU) 1, a Hard Disk Driver (HDD) 2, a Random Access Memory (RAM) RAM 3, and a communication unit 4. The CPU 1 may be electrically connected to each of the HDD 2, RAM 3, and communication unit 4. The CPU 1 and a storage device, e.g., the HDD 2 or RAM 3, may function as a computer of the central server CS. The HDD 2 may comprise a program storage area 21, a service identification information storage area 23, a device information storage area 24, a scan data storage area 25, and a session information storage area 26.

The program storage area 21 may comprise a main processing program storage area 22. The main processing program storage area 22 may store a program that carries out a main process of the central server CS. The program, for example, may be downloaded from a predetermined server in a network. The program may be recorded on a recording medium, such as a CD-ROM. The program may be read by a drive of the recording medium. The drive may be configured to be connectable of the central server CS.

The service identification information storage area 23 may store service identification information. The service identification information may indentify the first network service SC1, the second network service SC2, and the like. The service identification information may identify a network service provided via a network. The service identification information may identify a network service, the utilization of which is permitted by the central server CS.

The device information storage area 24 may store device information. The device information may identify a device, e.g., a scanner device, which is utilizable in the network system S. The device information may identify devices that are utilizable in the network system S, such as a scanner device, an image formation device, or a TV conference terminal that is connectable to a network. The user ID may be associated with the device information stored in the device information storage area 24. The user ID may be associated with one or more items of the device information. The information processing device IP may select a required device from among the plurality of devices associated with the user ID and may execute a scanning process. The device information may be associated with location information indicating the location of the device in the network. The location information may be stored in the device information storage area 24. The location information may comprise an IP address.

The scan data storage area 25 may store image data scanned by a scanner device. The scan data storage area 25 may store and associate the image data with the user ID. The external server ES1 or external server ES2 may acquire image data usable by a user in a network service based on the user's user ID. The scan data storage area 25 also may store and associate the image data with the service identification information.

The session information storage area 26 may store session information. The session information may identify a session between the central server CS and a scanner device. The session information may be information relating to a session between the central server CS and a device other than a scanner device that is connectable to a network. The session information may be information relating to a session between the central server CS and the relay device RD. The central server CS may store the session information between the central server CS and a scanner device or the relay device RD, such that the central server CS may transmit a scan command to the scanner device or relay device RD. The central server CS may store the session information, such that information may be transmitted and received between the central server CS and a scanner device or the relay device.

The RAM 3 may temporarily store information that is temporarily utilized by the central server CS. The communication unit 4 may execute communication with the information processing device IP, the first network service SC1, the second network service SC2, the first scanner device SD1, or the relay device RD, via the network NW.

### 4. Electrical Configuration of First scanner device SD1

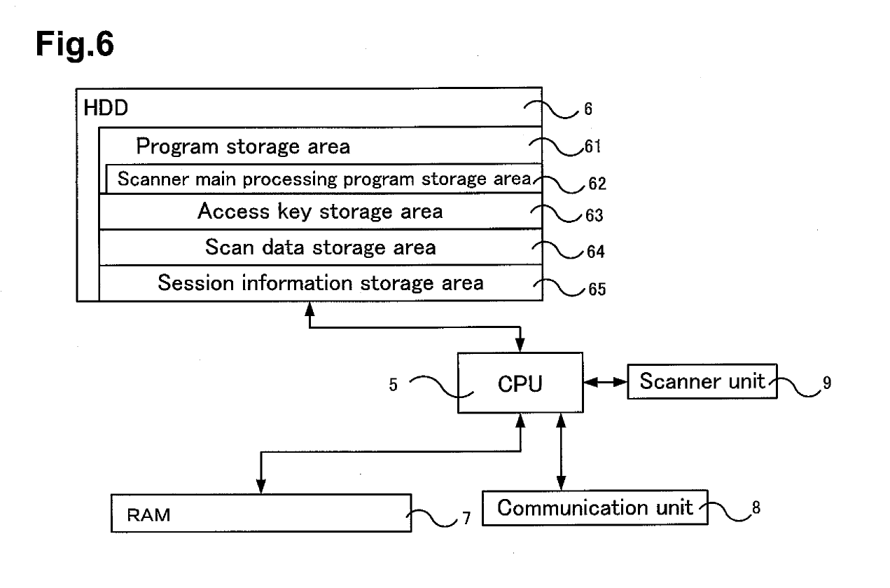

Referring to FIG. 6, the first scanner device SD1 may comprise a CPU 5, a HDD 6, a RAM 7, a communication unit 8, and a scanner unit 9. The CPU 5 may be electrically connected to each of the HDD 6, RAM 7, communication unit 8, and scanner unit 9. The CPU 5 and a storage device, e.g., the HDD 6 or RAM 7, may function as a computer of the first scanner device SD1.

The HDD 6 may comprise a program storage area 61, an access key storage area 63, a scan data storage area 64, and a session information storage area 65.

The program storage area 61 may comprise a scanner main processing program storage area 62. The scanner main processing program storage area 62 may store a program for executing a main process of the first scanner device SD1. The program may be downloaded from a predetermined server in a network. The program may be recorded on a recording medium, e.g., a CD-ROM. The program may be read by a drive of the recording medium. The drive may be configured to connect to the scanner device or the relay device RD.

The access key storage area 63 may store an access key. An access key may indicate authentication information used when the first scanner device SD1 accesses the central server CS. The scan data storage area 64 may store image data scanned by the scanner unit 9.

The session information storage area 65 may store session information relating to a session between the central server CS and the scanner device. The first scanner device SD1 or central server CS may regularly carry out a session confirmation, and the session information may then be stored in the session information storage area 65. The first scanner device SD1 may store the session information, and the first scanner device SD1 may then receive a scan command transmitted from the central server CS.

The RAM 7 may temporarily store information that is temporarily utilized by the first scanner device SD1. The communication unit 8 may execute communication with the central server CS, the information processing device IP, the first network service SC1, the second network service SC2, or the relay device RD, via the network NW.

The scan unit 9 may be configured to scan a document set in the first scanner device SD1. Specifically, the scan unit 9 may comprise a conveyor roller, an image scanning sensor, and the like. The image scanning sensor may be an imaging element, e.g., a contact image sensor (CIS), a charge coupled device (CCD), or the like. The scan unit 9 may be driven and controlled by the CPUS to scan the document to acquire the image data.

The electrical configuration of the relay device RD may be substantially similar to the electrical configuration of the first scanner device SD1. The relay device RD may not include the scan unit 9. The relay device RD may be configured to connect to the second scanner device SD2. The second scanner device SD2 may scan the document to obtain the scanned image data and transmit the scanned image data to the relay device RD. The relay device RD may store image data scanned by the second scanner device SD2 in the scan data storage area 64 of the relay device RD, and upload the image data to the central server CS.

### 5. Main Process of Central Server CS

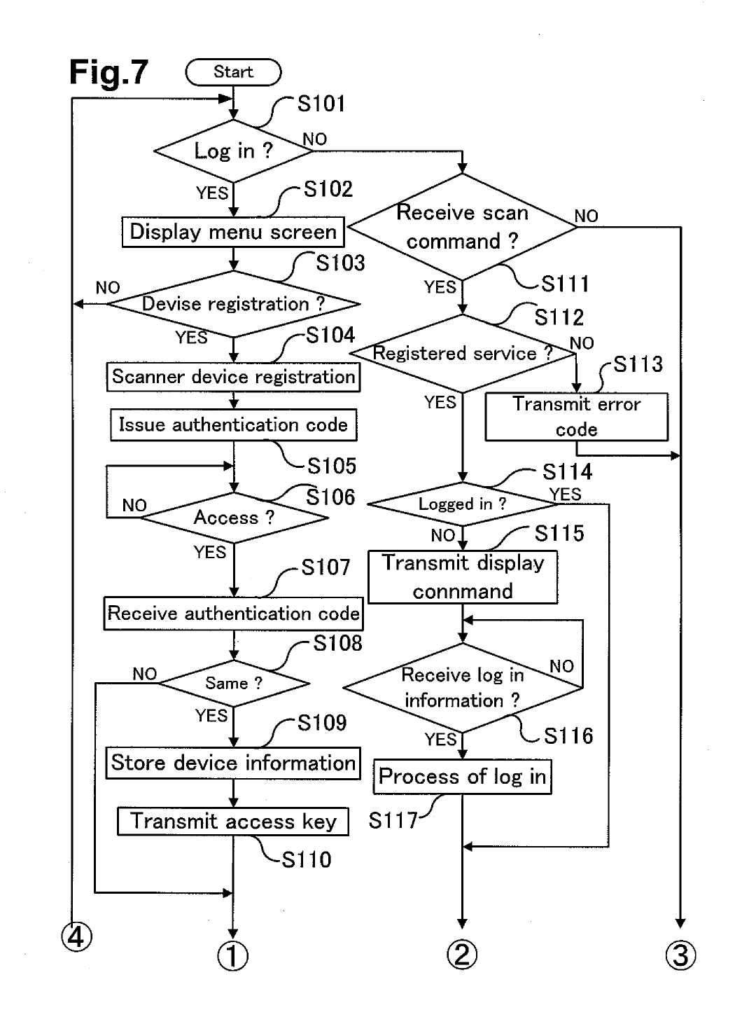

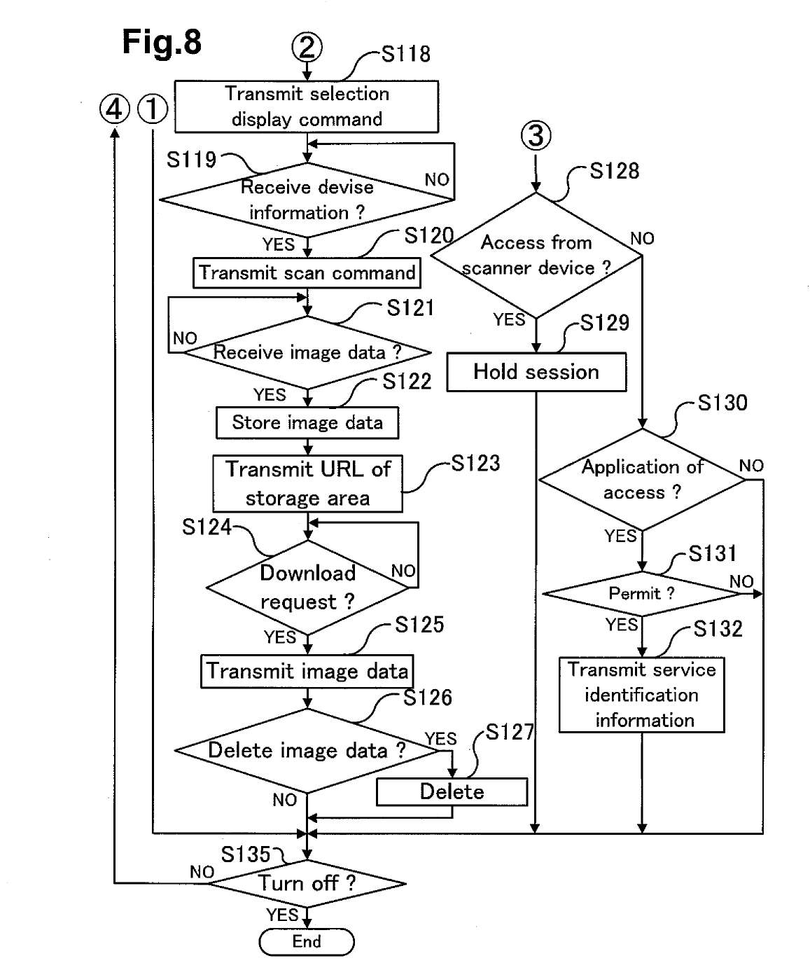

Referring to FIGS. 7 and 8, the process of the central server CS may be implemented when a power supply of the central server CS is turned on. Processes may be executed by the CPU 1.

In step S101, a process of logging in to a service utilized by the central server CS may be executed. Specifically, a login ID for logging in to the central server CS may be used. When the process of logging in is executed, e.g., YES at step S101, step S102 may be executed. When the process of logging in is not executed, e.g. NO in step S101, step S111 may be executed.

In step S102, a menu screen may be displayed. The menu utilizable by the central server CS may be displayed in a display unit of the information processing device IP. A browser installed in the information processing device IP may be used for displaying the menu of the network service.

In step S103, whether a device registration process has been selected from the menu screen may be determined. When the device registration process has been selected, e.g., YES in step S103, step S104 may be executed. If no device registration process has been selected, e.g., NO in step S103, step S101 may be executed. The device registration process in step S103 may be applicable to one or more of the information processing device IP, the first scanner device SD1, and the relay device RD.

In step S104, a scanner device registration process may be executed. The scanner device registration process may be a process of registering a device utilizable by the user who has logged in to the service in step S101. Device information given to the device registered in step S104 may be associated with the login ID, and may be stored in the device information storage area 24. The login ID may be the login ID used at the process of logging in to the service in of step S101. In another embodiment, the device information given to the registered device may be stored in the device information storage area 24, without associating with the login ID.

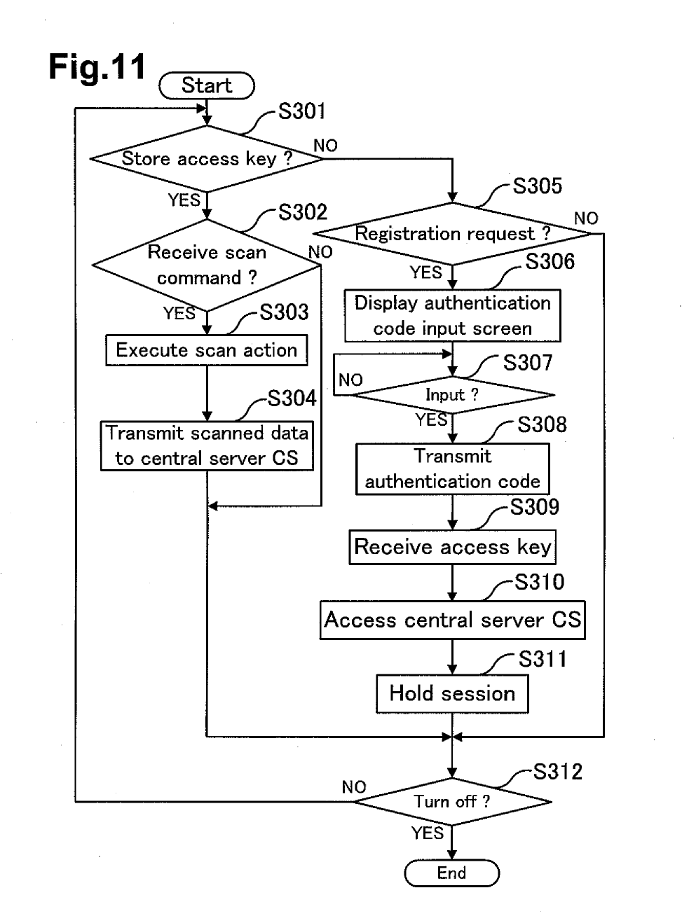

In step S105, an authentication code may be issued to the device that has applied for the registration process in step S103. An authentication code may be transmitted to the device that has applied for the registration process in step S103. The authentication code may be a code for executing an authentication of the first scanner device SD1 or relay device RD. The authentication code may be displayed in a display unit included in the information processing device IP or relay device RD. The authentication code also may be displayed in a display unit included in the first scanner device SD1. The authentication code issued in step S105 may be input in step S307, as shown in FIG. 11.

In step S106, whether the central server CS has been accessed by the scanner device may be determined. When the central server CS has been accessed, e.g., YES in step S106, step S107 may be executed. If the central server CS has not been accessed, e.g., NO in step S106, step S106 may be executed again. When a predetermined period elapses after step S106 is executed again, the process may return to step S101.

In step S107, an authentication code may be received from the device which has been accessed in the step S106. If the central server CS has been accessed from the first scanner device SD1 in step S106, the authentication code transmitted in step S308 may be received in step S107.

In step S108, whether the authentication code is received in step S107 is the same as the authentication code issued in step S105 may be determined. If the authentication code received in step S107 and the authentication code issued in step S105 are the same, e.g., YES in step S108, step S109 may be executed. If the authentication code received in step S107 and the authentication code issued in step S105 are not the same, e.g., NO in step S108, step S135 may be executed.

In step S109, device information given to the authenticated device, a user ID utilized in the first network service SC1 or second network service SC2, and location information of the authenticated device may be associated and stored in the device information storage area 24. The location information may be information indicating a location in the network NW. The location information may be an IP address given to the authenticated device. In another embodiment, the device information given to the registered device may be stored in the device information storage area 24, without being associated with other information. The authenticated device may be the relay device RD connected to the first scanner device SD1 or second scanner device SD2. In step S109, the device information, service identification information of the first network service SC1 or second network service SC2, and location information may be associated and stored in the device information storage area 24.

In step S110, an access key may be transmitted to the registered device. The access key may be information for enabling a scanner device or the relay device RD to access the central server CS. The access key transmitted in step S110 may be received in step S309, as shown in FIG. 11.

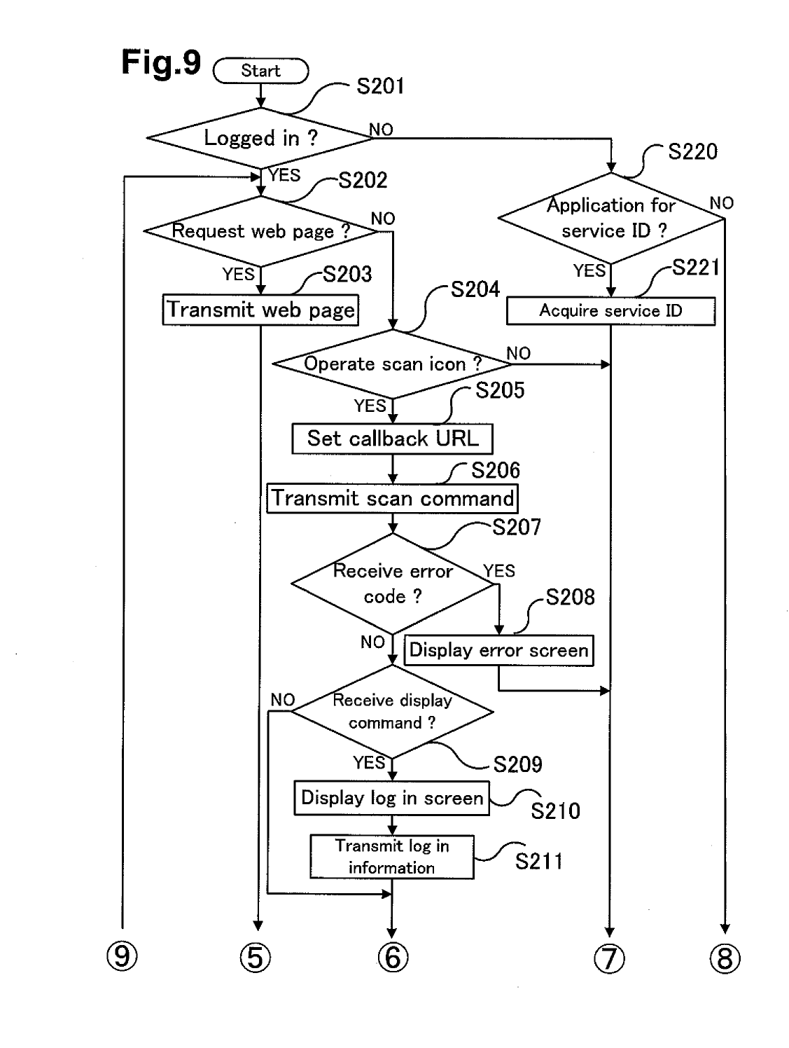

In step S111, whether a scan command has been received may be determined. The scan command may be a scan instruction application program interface (API) of the central server CS. If the scan command has been received, e.g., YES in step S111, step S112 may be executed. If no scan command has been received, e.g., NO at step S111, step S128 may be executed. The scan command received in step S111 may be transmitted in step S206, as shown in FIG. 9. The scan command received in step S111 may comprise a uniform resource locator (URL) of the external server to notify the central server CS that the scanning of image data by the scanner device is completed. An IP address of the external server may be included in the scan command instead of the URL of the external server.

In step S112, whether a network service provided by the external server that has transmitted the scan command to the central server CS is a registered network service may be determined. Service identification information may be acquired from the external server that has transmitted the scan command to the central server CS. Whether the acquired service identification information is stored in the service identification information storage area 23 may then be determined. If the information is stored, the network service provided by the external server may be determined to be a registered network service. If it is determined that the information is not stored, the network service provided by the external server may be determined not to be a registered network service. If the network service provided by the external server is determined to be a registered network service, e.g., YES in step S112, step S114 may be executed. If the network service provided by the external server is not a registered network service, e.g., NO step S112, step S113 may be executed.

In step S113, an error code may be transmitted to the external server that has transmitted the scan command to the central server CS.

In step S114, whether the process of logging in to the central server CS is completed may be determined. If the logging in process is completed, e.g., YES in step S114, step S118 may be executed. If the logging in process is not completed, e.g., NO in step S114, step S115 may be executed.

In step S115, a display command for displaying a login screen on the display of the information processing device IP or relay device RD may be transmitted to the information processing device IP or relay device RD. Based on the display command, the log in screen may be displayed on a display unit of the information processing device IP or of the relay device RD.

In step S116, whether the login information has been received may be determined. If the login information has been received, e.g., YES in step S116, step S117 may be executed. If no login information has been received, e.g., NO in step S116, step S116 may be executed again. The login information may comprise a login ID for logging in to the central server CS and a password. When a predetermined period elapses after step S116 is repeated, the process may return to step S101.

In step S117, a process of logging in may be executed based on the login information received in step S116.

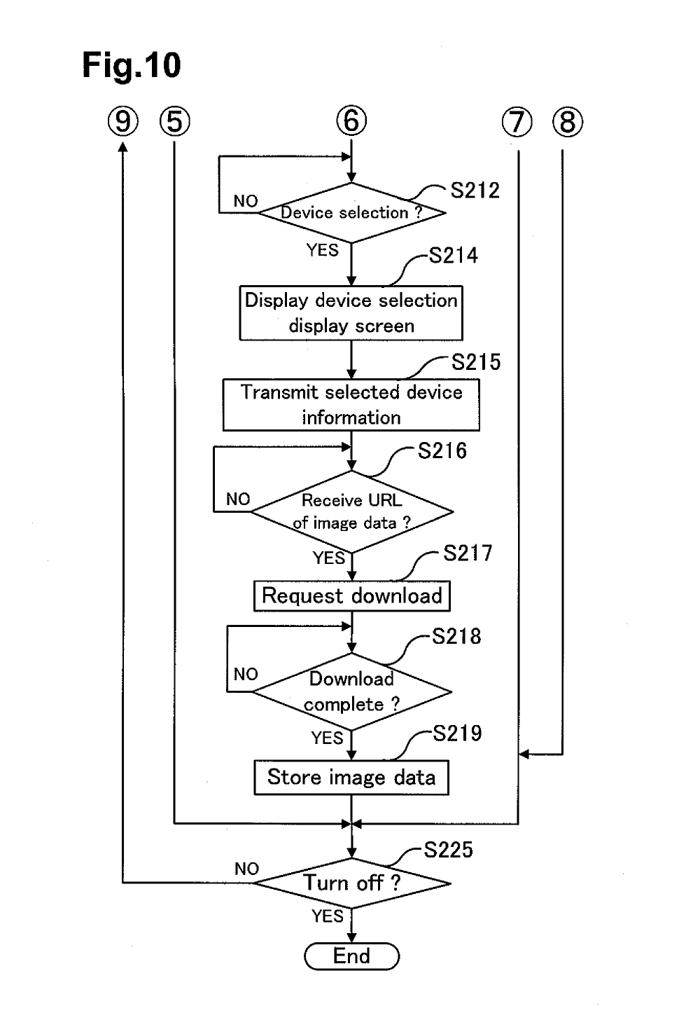

In step S118, a selection display command may be transmitted to the information processing device IP or relay device RD. The selection display command may be a command that instructs a information processing device IP or scanner device to display a screen for selecting a device, e.g., a scanner device, connected to the network NW. Based on the selection display command, the screen for selecting a device may be displayed in a display unit of the information processing device IP or of the relay device RD. Specifically, a user ID, login ID, or service identification information of a network service utilized by the information processing device IP or relay device RD may be acquired from the information processing device IP, an external server, or the relay device RD. If the user ID, the login ID, or the service identification information is stored in the central server CS, the user ID, the log in ID, or the service identification information may not be acquired from the information processing device IP, an external server, or the relay device RD. The device information associated with the acquired user ID, log in ID, or service identification information may be determined from the device information storage area 24. The selection display command instructing information processing device IP or the relay device RD or external server to display the determined device information for selection may be transmitted to the information processing device IP, relay device RD, or external server. The selection display command may be transmitted to an external server. The transmitted selection display command may be received in step S212, as shown in FIG. 10.

In step S119, whether the device information has been received may be determined. Whether the device information transmitted in step S215 of FIG. 10 has been received may be determined. If the device information has been received, e.g., YES in step S119, step S120 may be executed. If the device information has not been received, e.g., NO in step S119, step S119 may be executed again. When a predetermined period elapses after step S119 is repeated, the process may return to step S101.

In step S120, the scan command may be transmitted to the device indicated by the device information received in step S119. Specifically, the location information associated with the device information received in step S119 may be determined from the device information storage area 24. The scan command may be transmitted based on the determined location information. The scan command transmitted in step S120 may be received in step S302 of FIG. 11.

In step S121, whether image data have been received may be determined. Specifically, whether image data uploaded by the scanner device have been received may be determined. If the image data have been received, e.g., YES in step S121, step S122 may be executed. If no image data have been received, e.g., NO in step S121, step S121 may be executed again. When a predetermined period elapses after step S121 is repeated, the process may return to step S101. The image data received in step S121 may be image data transmitted in step S304 of FIG. 11.

In step S122, the image data received in step S121 may be stored in the scan data storage area 25. The received image data may be associated with the user ID, service identification information, or login ID of the network service utilized by the information processing device IP and stored in the scan data storage area 25.

In step S123, a URL of the storage area, in which the image data are stored, may be transmitted toward the URL received in step S111. The URL of the storage area may be information indicating a storage destination of the scan data storage area 25 in which the image data are stored. The URL transmitted in step S123 may be received in step S216, as shown in FIG. 10.

In step S124, whether a download request is received for the URL transmitted in step S123 may be determined. If the download request is received, e.g., YES in step S124, step S125 may be executed. If the download request is not received, e.g., NO in step S124, step S124 may be executed again. When a predetermined period elapses after step S124 is repeated, the process may return to step S101. The download request received in step S124 may be a request generated in step S217, as shown in FIG. 10.

In step S125, in response to requesting download in the step S124, image data may be transmitted to the request source external server or storage server. The transmitted image data may be received in step S218, as shown in FIG. 10.

In step S126, whether the network service is a service that deletes image data may be determined. Specifically, the service identification information indicating the network service, to which the download request source external server or storage server belongs, may be acquired from the request source external server or the storage server. The service identification information acquired in step S112 may be used. A “deletable” flag corresponding to the service identification information may be stored in the service identification information storage area 23. The “deletable” flag may indicate whether the network service is a service that deletes image data. The “deletable” flag may be stored in the service identification information storage area 23, in response to executing step S132. Thus, based on the acquired service identification information and “deletable” flag, whether the network service is a service that deletes image data may be determined. If the network service is a service that deletes image data, e.g., YES in step S126, step S127 may be executed. If the network service is not a service that deletes image data, e.g., NO in step S126, step S135 may be executed.

In step S127, the image data determined to be deleted in step S126 may be deleted from the scan data storage area 25.

In step S128, whether the central server CS has been accessed by the scanner device may be determined. If the central server CS has been accessed by the scanner device, e.g., YES in step S128, step S129 may be executed. If the central server CS has not been accessed by a scanner device, e.g., NO in step S128, step S130 may be executed. The access received in step S128 may be an access executed in step S310, as shown in FIG. 11.

In step S129, a session between the scanner device accessed in the step S128 and the central server CS may be held. Specifically, information relating to a session between the scanner device accessed in step S128 and the central server CS may be stored in the session information storage area 26.

In step S130, whether a network service has applied to access the central server CS may be determined. The application for access may be an application in which the external server of the external network service obtains permission to utilize the central server CS. If access has been applied for the central server CS, e.g., YES in step S130, step S131 may be executed. If no access has been applied for the central server CS, e.g., NO in step S130, step S135 may be executed.

In step S131, whether the utilization of the central server CS by the network service requested in the step S130 is permitted may be determined. If the utilization of the central server CS is permitted, e.g., YES in step S131, step S132 may be executed. If the utilization of the central server CS is not permitted, e.g., NO in step S131, step S135 may be executed.

In step S132, the service identification information may be given to the network service to which utilization has been permitted in step S131. Then, the given service identification information may be stored in the service identification information storage area 23. The given service identification information may be transmitted to the network service that has made the application in step S130.

In step S135, whether the power supply of the central server CS or a program of the central server CS has been turned off may be determined. If the power supply has been turned off, e.g., YES in step S135, the main action process may end. If the power supply has not been turned off, e.g., NO in step S135, step S101 may be executed.

### 6. Main Process of External Server ES1 or External Server ES2

Referring to FIGS. 9 and 10, the process of the external server ES1 or the external server ES2 may be implemented when a power supply of the external server ES1 or external server ES2 is turned on. Processes may be executed by the CPU of the external server ES1 or of the external server ES2.

In step S201, whether a user has logged in to the first network service SC1 provided by the external server ES1 may be determined. Specifically, a logging in process may be executed using a web page provided by the external server ES1 and a user ID. If a user has logged in to the first network service SC1 provided by the external server ES1, e.g., YES in step S201, step S202 may be executed. If no user has logged in to the first network service SC1 provided by the external server ES1, e.g., NO in step S201, step S220 is executed.

In step S202, whether a web page has been requested may be determined. If a web page has been requested, e.g., YES in step S202, step S203 may be executed. If a web page has not been requested, e.g., NO in step S202, step S204 may be executed.

In step S203, the web page on which the scan icon IC2 is displayed, as shown in FIG. 3, may be transmitted to the web page request source of step S202.

In step S204, whether the scan icon IC2, as shown in FIG. 3, has been operated may be determined. If the scan icon IC2 has been operated, e.g., YES in step S204, step S205 may be executed. If the scan icon IC2 has not been operated, e.g., NO in step S204, step S225 may be executed. In step S204, a both-side scanning mode, one-side scanning mode, or the like, of a document may be set, in response to operating the scan icon IC2. A drop box may be displayed in accordance with an operation of the scan icon IC2, from which a both-side scanning more or one-side scanning mode may be selected.

In step S205, a callback URL may be set. The callback URL may indicate a notification destination, to which a notification indicating that image data have been scanned and uploaded may be sent. The callback URL may indicate the location of the external server ES1.

In step S206, a scan command and the callback URL may be transmitted to the central server CS. The scan command transmitted in step S206 may be a command in accordance with the setting operation in step S204. When, as shown in FIG. 3, the one-side scanning mode is selected as a scan command, the scan command indicating a one-side scanning mode may be transmitted. When, as shown in FIG. 3, the both-side scanning mode is selected as a scan command, the scan command indicating a both-side scanning mode may be transmitted.

In step S207, whether an error code has been received may be determined. The error code may indicate that the information transmitted in step S206 is not permitted by the central server CS due to certain error. If an error code has been received, e.g., YES in step S207, step S208 may be executed. If no error code has been received, e.g., NO in step S207, step S209 may be executed. The error code received in step S207 may be an error code transmitted in step S113, as shown in FIG. 7.

In step S208, an error screen may be displayed. Specifically, a web page representing an error screen may be transmitted from the external server ES1 to the information processing device IP or to the relay device RD.

In step S209, whether a display command has been received from the central server CS may be determined. The display command received in step S209 may be the login screen display command transmitted in step S115, as shown in FIG. 7. The login screen display command may be a command instructing a display of the request source of the scan command to show a login screen. The login screen may allow the user of the information processing device IP to log in to the central server CS. Thus, the external server ES1 may cause the information processing device IP to display a login screen, and cause the information processing device IP to execute logging in process using a log in ID. If a display command has been received, e.g., YES in step S209, step S210 may be executed. If no display command has been received, e.g., NO in step S209, step S212 may be executed.

In step S210, a login screen may be displayed in the information processing device IP or in the relay device RD. Specifically, a web page representing a login screen may be transmitted from the external server ES1 to the information processing device IP orto the relay device RD. Login information for logging in may then be acquired from the information processing device IP or from the relay device RD. The login information may be a combination of a login ID and a password, or the like.

In step S211, the login information acquired in step S210 may be transmitted to the central server CS.

In step S212, whether the device selection screen display command transmitted in step S118 has been received may be determined. If the device selection screen display command has been received, e.g., YES in step S212, step S214 may be executed. If the device selection screen display command has not been received, e.g., NO in step S212, step S212 may be executed again. When a predetermined period elapses after step S212 is repeated, the process may return to step S202.

In step S214, a device selection display screen may be displayed. The external server ES1 may cause the information processing device IP or the relay device RD to display the device selection display screen, and cause the information processing device IP or the relay device RD to select information regarding the device to which a scan command is to be transmitted.

In step S215, the device information selected in step S214 may be transmitted to the central server CS.

In step S216, whether a URL of image data has been received may be determined. The URL received in step S216 may be the URL transmitted in step S123, as shown in FIG. 8. The URL of image data may indicate a store destination of the scanned image data by a scanner device. If the URL of image data has been received, e.g., YES in step S216, step S217 may be executed. If the URL of image data has not been received, e.g., NO in step S216, step S216 may be executed again. When a predetermined period elapses after step S216 is repeated, the process may return to step S202.

In step S217, a download of the image data may be requested. The download request may be transmitted to a destination indicated by the URL received in step S216.

In step S218, whether the download of image data requested in step S217 is completed may be determined. Image data downloaded in step S218 may be the image data transmitted in step S125, as shown in FIG. 8. If the download is completed, e.g., YES in step S218, step S219 may be executed. If the download is not completed, e.g., NO in step S218, step S218 may be executed again. When a predetermined period elapses after step S218 is repeated, the process may return to step S202.

In step S219, the downloaded image data may be stored in the external server ES1. The image data stored in the external server ES1 may be forwarded to the first storage server SV1 or second storage server SV1. The processes of steps S216 to S219 may be executed by one or more of the storage servers SV1 to SV4 of the first network service SC1 or the second network service SC2.

In step S220, whether an application for a service ID has been made to the central server CS may be determined. If an application has been made, e.g., YES in step S220, step S221 may be executed. If application has not been made, e.g., NO in step S220, step S225 may be executed.

In step S221, the service ID applied for in step S220 may be acquired. Specifically, the service identification information transmitted in step S132, as shown in FIG. 8, may be acquired. The service ID acquired from the central server CS may then be stored in the external server ES1.

In step S225, whether the power supply of the external server ES1 or a program of the external server ES1 has been turned off may be determined. If the power supply has been turned off, e.g., YES in step S225, the main process of the external server ES1 may end. If the power supply has not been turned off, e.g., NO in step S225, step S202 may be executed. When a logging out process has been executed, the process may return to step S201.

### 7. Main Process of First scanner device SD1 or Relay Device RD

Referring to FIG. 11, the main process of the first scanner device SD1 or of the relay device RD may be implemented when a power supply of the first scanner device SD1 or of the relay device RD is turned on. Processes may be executed by the CPU 5 of the first scanner device SD1 or of the relay device RD.

In step S301, whether an access key is stored in the access key storage area 63 may be determined. If an access key is stored, e.g., YES in step S301, step S302 may be executed. If no access key is stored, e.g., NO in step S301, step S305 may be executed.

In step S302, whether the scan command has been received may be determined. The scan command received in step S302 may be the scan command transmitted in step S120 of the central server CS. If the scan command has been received, e.g., YES in step S302, step S303 may be executed. If scan command has not been received, e.g., NO in step S302, step S312 may be executed.

In step S303, a scanning action may be executed. Specifically, the scanner unit 9 may be driven based on the scan command received in step S302. In accordance with the scan command, image data may be scanned from a document conveyed in a scanner device. The scanned image data may be stored in the scan data storage area 64. In the relay device RD, the scan command received in step S302 may be forwarded to the second scanner device SD2, which is connected to the relay device RD. The second scanner device SD2, to which the scan command has been forwarded, may then execute a scanning action to obtain image data from a document. The relay device RD may acquire the image data from the second scanner device SD2. The acquired image data may be stored in the scan data storage area 64 of the relay device RD.

In step S304, the image data scanned in step S303 or the image data acquired in step S303 may be transmitted, e.g., uploaded, to the central server CS.

In step S305, whether a scanner device registration has been requested from a user using the first scanner device SD1 or the relay device RD may be determined. A registration request may be a process of registering the first scanner device SD1 or the second scanner device SD2, such that the registered device is utilizable in the network system S. If the scanner registration has been requested, e.g., YES in step S305, step S306 may be executed. If the scanner registration has not been requested, e.g., NO in step S305, step S312 may be executed.

In step S306, an authentication code input screen is displayed. The authentication code input screen represents a screen allowing users to input authentication code. Specifically, the authentication code input screen is displayed on a display comprised in the first scanner device SD1 or on a display of the relay device RD.

In step S307, whether the authentication code has been input may be determined. If the authentication code has been input, e.g., YES in step S307, step S308 may be executed. If the authentication code has not been input, e.g., NO in step S307, step S307 may be executed again. When a predetermined period elapses after step S307 is repeated, the process may return to step S301. The authentication code input in step S307 may be the authentication code issued in step S105, as shown in FIG. 7.

In step S308, the authentication code input in step S307 may be transmitted to the central server CS.

In step S309, the access key transmitted by the central server CS in step S110 may be received. The received access key may then be stored in the access key storage area 63.

In step S310, access of the central server CS may be started based on the access key received in step S309.

In step S311, a session between the central server CS accessed in step S310, and the first scanner device SD1 or relay device RD may be held. Specifically, information relating to a session between the central server CS accessed in step S310, and the first scanner device SD1 or relay device RD may be stored in the session information storage area 65.

In step S312, whether the power supply of the first scanner device SD1 or relay device RD has been turned off may be determined. If the power supply has been turned off, e.g., YES in step S312, the main process of the first scanner device SD1 or relay device RD may end. If the power supply has not been turned off, e.g., NO in step S312, step S301 may be executed.

### Second Embodiment

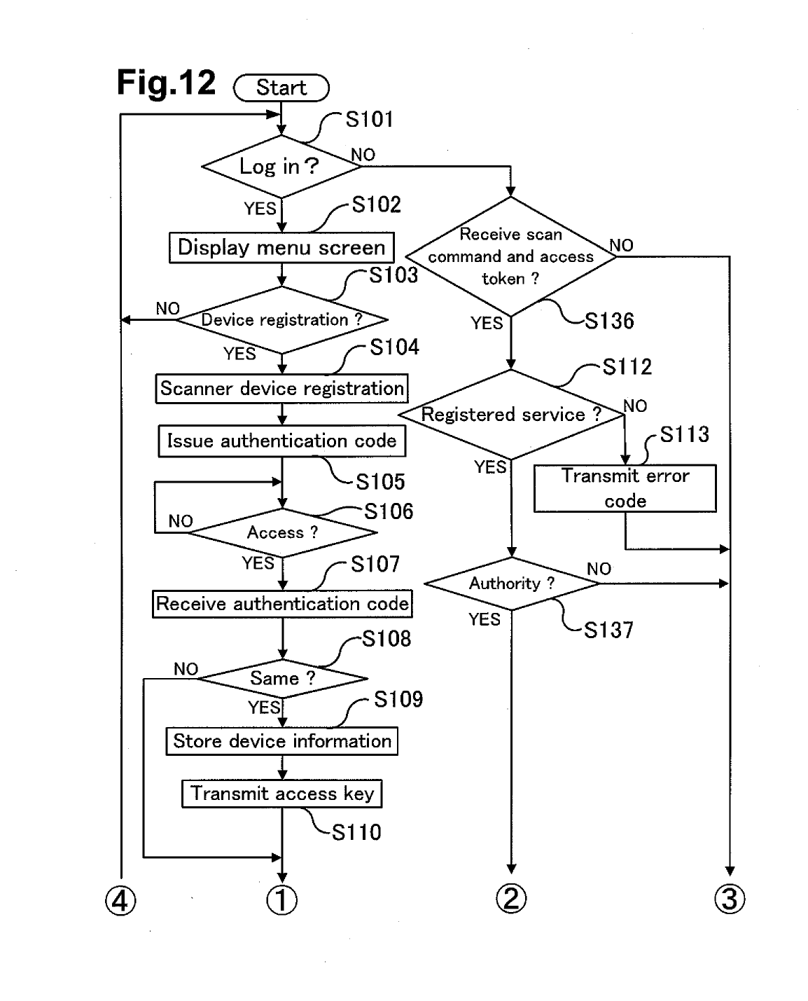

Referring to FIGS. 12-15, in the second embodiment, the central server CS logging in process of steps S114 to S117, as shown in FIG. 7, may be omitted.

As shown in FIG. 12, in contrast to step S111 in FIG. 7, in step S136, whether a scan command and an access token have been received may be determined. The access token may be information indicating authority to use the central server CS. If the scan command and the access token have been received, e.g., YES in step S136, step S112 may be executed. If the scan command and access token have not been received, e.g., NO in step S136, step S128 may be executed.

If the network service is determined to be a registered service in step S112, step S137 may be executed instead of steps S114 to S117 in FIG. 7 of the first embodiment. In step S137, the authority to utilize the central server CS may be determined based on the access token received in step S136. Specifically, whether the access token received in step S136 is registered in an access token database stored in a predetermined storage area of the HDD 2 may be determined. If the access token is registered, the received access token may be determined to have authority. If the access token is not registered, the received access token may be determined not to have authority. If received access token is determined to have authority, YES in step S137, step S118 may be executed. If the received access token is determined not to have authority, e.g., NO in step S137, step S128 may be executed.

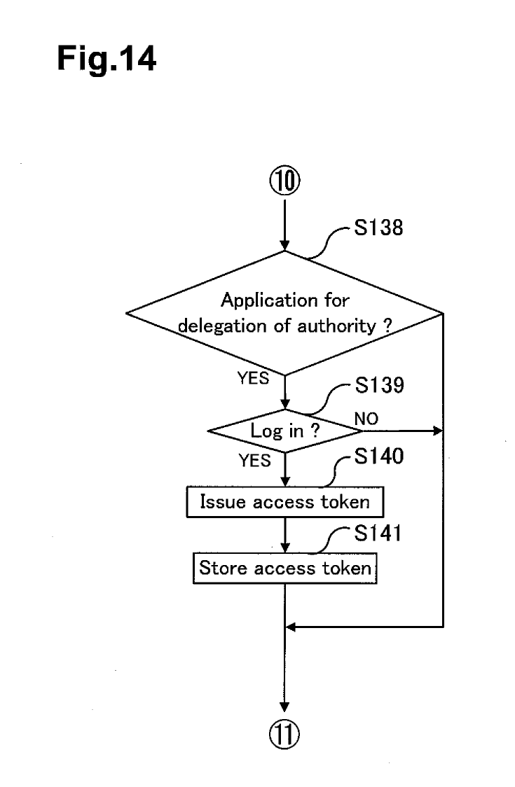

As shown in FIG. 14, in step S138, whether an application for delegation of authority is requested may be determined. If the application for delegation of authority has been requested, e.g., YES in step S138, step S139 may be executed. If the application for delegation of authority has not been requested, e.g., NO in step S138, step S135 may be executed.

As shown in FIG. 14, in step S139, whether login process has been executed may be determined. If the login process is successful, e.g., YES in step S139, step S140 may be executed. If the login process failed, e.g., NO in step S139, step S135 may be executed.

Also, as shown in FIG. 14, an access token may be issued in step S140. The issued access token may be transmitted to the application requester of step S138.

In step S141, the login ID for logging in to the access in step S101, the access token issued in step S140, and the service ID of application source in the step S138 may be associated with each other, and may be registered in the access token database of the HDD 2.

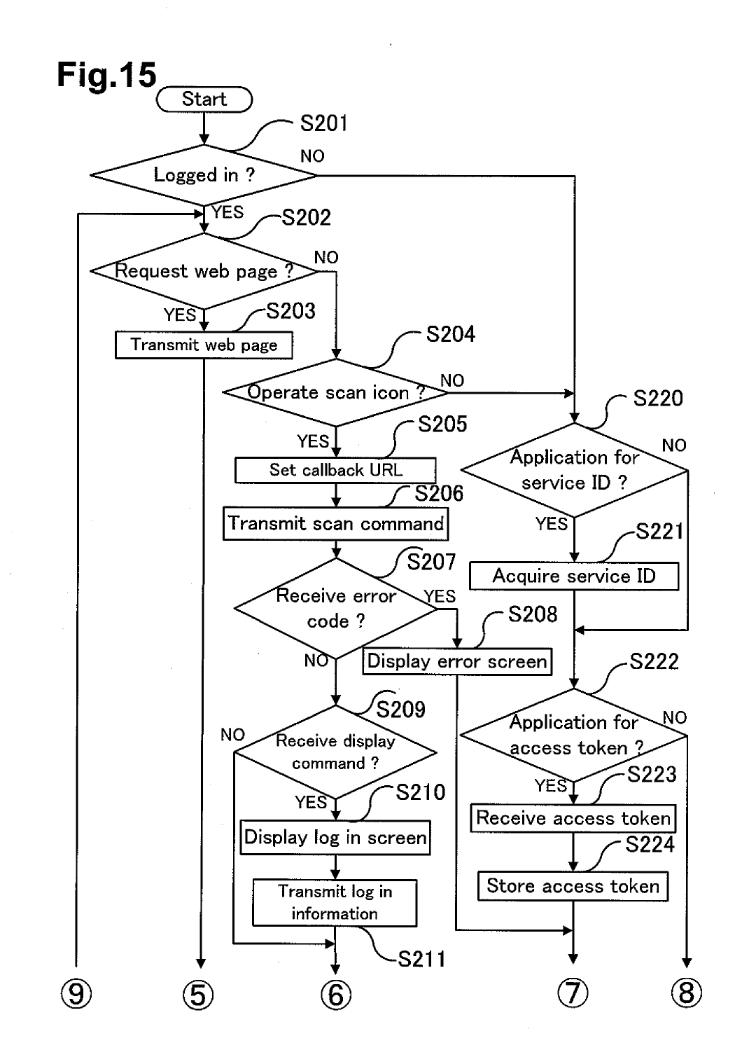

As shown in FIG. 15, in step S222, whether application for access token is requested may be determined. If the application for access token has been requested, e.g., YES in step S222, step S223 may be executed. If the application for access token has not been requested, e.g., NO in step S222, step S225 may be executed.

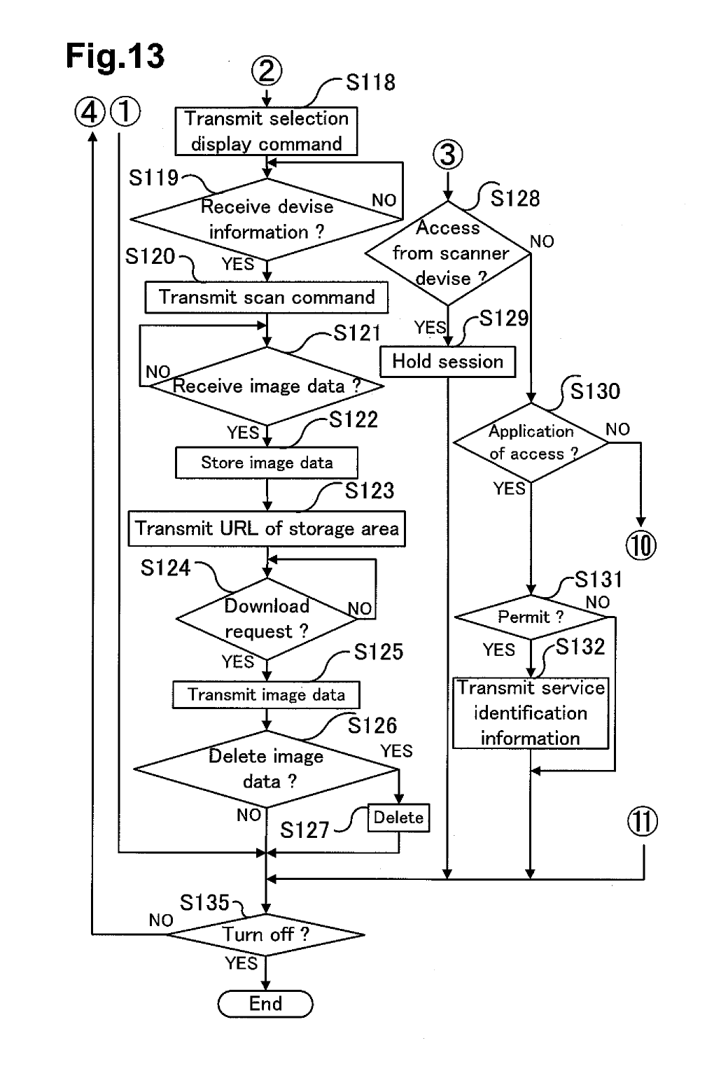

In step S223, an access token may be received, based on the service ID application approved by the central server CS. The access token received in step S223 may be the access token transmitted in step S140 of FIG. 13. In step S224, the access token received in step S223, the log in ID used when logging in in step S101, and the service ID of the external server ES1 may be associated with each other and saved in a predetermined storage area of the external server ES1. The access token saved in step S224 may be transmitted together with the scan command to the central server CS in step S206. The scan command and access token then may be received in step S136 of FIG. 12. Thus, the service of the central server CS may be utilized, without executing a logging in process.

The external servers ES1 and ES2, or of the storage servers SV1 to SV4, may be storage devices that are utilized with a web page. In another embodiment, the storage devices may be utilized with a network service that manages a web page.

Image data uploaded to the central server CS may be downloaded by the external servers ES1 and ES2 or by the storage servers SV1 to SV4. In another embodiment, uploaded image data may be transmitted by the central server CS to the external servers ES1 and ES2 or to the storage servers SV1 to SV4

In step S120, the scan command may be transmitted to the device indicated by the device information received in step S119. Specifically, the application program interface (API) of the scanner device may be called as the scan command. In another embodiment, only a signal indicating a scan command, rather than the API call, may be transmitted to the device indicated by the device information received in step S119. When the signal indicates that the scan command is received by the scanner device, the scanner device software may start up, and the scan command may be executed.

The device to which the scan command is to be transmitted may be selected by the processes of steps S118 to S120, as shown in FIG. 8, and the processes of steps S214 and S215, as shown in FIG. 10. The device to which the scan command is to be transmitted may be determined automatically. Specifically, the device information given to the device registered in step S104 and the user ID or service identification information utilized with the first network service SC1 or second network service SC2 are associated with each other, and stored in the device information storage area 24. Thus, a plurality of items of device information may be registered with respect to one user ID or item of service identification information, because a plurality of scanner devices may be connected to a network, and the user may utilize the plurality of scanner devices. In step S104, the login ID of the central server CS and the device information given to the device registered may be associated, and stored in the device information storage area 24. Thus, a plurality of items of device information may be registered with respect to one login ID.

When a plurality of items of device information are registered with respect to one user ID or log in ID, the device to which the scan command is to be sent may be automatically determined from among the plurality of items of device information, instead of based on the selection display command transmitted in step S118. Specifically, the device to which the scan command is to be sent may be automatically determined from among the plurality of items of device information, based on the service identification information acquired in step S112. The service identification information of each network service and the device information to be used may be associated with each other, and stored on the HDD 2. Because the device information associated with the service identification information is uniquely determined from among the plurality of items of device information, the device information may be automatically determined.

In step S112, the user ID used when logging in to the network service may be acquired. The device, to which the scan command is to be sent, may be automatically determined from among the plurality of items of device information, based on the user ID acquired in step S112, because the user ID may be associated with the device information used by the user, and stored on the HDD 2. Thus, the device information associated with the user ID may be identified from among the plurality of items of device information, and the device information may be automatically determined. When a plurality of items of device information are registered with respect to one user ID, login ID, or item of service identification information, device information may indicate the device in which a document is set for scanning The device, in which the document is set, may be determined as the device to which the scan command is transmitted. A document detecting sensor may be installed in a scanner device, image formation device, and the like. When the scanner device or image formation device determines, using the document detecting sensor, that a document is set, the scanner device or image formation device may notify the central server CS that a document is set. Thus, the central server CS may identify the scanner device or image formation device in which the document is set, from among the plurality of items of device information, as the device to which the scan command is to be transmitted.

One or more items of device information may be associated with a combination of service identification information and user ID, and may be stored on the HDD 2. The device, to which the scan command is sent, may be automatically determined from among the plurality of items of device information, based on the service identification information acquired in step S112 and the user ID. Thus, when the device information associated with the combination of service identification information and the user ID is identified from among the plurality of items of device information, the device information may be automatically determined.

In the first embodiment, the logging in process may use the user ID utilized with the network service CS1 or network service CS2 and the log in ID utilized with the central server CS. In the second embodiment, the logging in process may utilize an access token. When an access token is not used, the user ID and log in ID may be associated and stored in the central server CS and the user ID may be acquired in step S112. Thus, instead of executing a logging in process in steps S115 to S117 of the first embodiment, the central server CS may execute a logging in process automatically using the login ID acquired in step S112 associated and stored with the user ID.

Image data may be uploaded to a storage device of the first network service SC1 or second network service SC2 by the first scanner device SD1 or second scanner device SD2 operated by the user of the first network service SC1 or the second network service SC2. In another embodiment, a video imaging device may be used instead of the first scanner device SD1 or second scanner device SD2. A video imaging device may be a digital camera, a TV conference terminal, or the like. A device configured to acquire or generate still image data or video data may be used instead of the first scanner device SD1 or the second scanner device SD2.

While the invention has been described connection with various exemplary structures and illustrative embodiments, it will be understood by those skilled in the art that other variations and modifications of the structures and the embodiments describes above may be made without departing from the scope of the invention. Other structures and embodiments will be apparent to those skilled in the art from the descriptions of the specification, including the accompanying figures, or from practice of the invention disclosed herein. It is intended that the specification and described examples are illustrative with the true scope of the invention being defined by the following claims.

1. A data server is configured to be connectable to an image scanning device via a network, the data server processing device comprising:
a processor having computer readable instruction stored thereon and configured to control the data server to execute steps of:
acquiring location information indicating a location of a service providing device in the network, wherein the service providing device is configured to be operated in the network via a web page and the web page comprises operating information for instructing the image scanning device to execute a scanning process;
determining an image scanning device to which an operation signal for executing an image scanning process is transmitted in response to operation of the operating information in the web page;
transmitting the operation signal to the determined image scanning device via the network to cause the determined image scanning device to execute an image scanning process;
storing scanned data obtained from the image scanning process of the determined image scanning device in a memory; and
instructing the service providing device indicated by the acquired location information to acquire the scanned data stored in the memory.

2. The data server according to claim 1,
wherein the data server is connected to a plurality of image scanning devices via the network, and
wherein the processor is further configured to control the data server to execute steps of:
acquiring user identification information identifying a user operating the operation information in the web page;
storing the user identification information in the memory and associating the user identification information with device identification information that identifies one of the plurality of image scanning devices corresponding to the user identification information;
determining the device identification information corresponding to the acquired user identification information in the memory; and
transmitting the operation signal to the image scanning device indicated by the determined device identification information.

3. The data server according to claim 2,
wherein the step of determining the device identification information comprises the step of determining the image scanning device, for which operating information of the web page instructs to execute a scanning process, from the plurality of the image scanning devices.

4. The data server according to claim 2,
wherein the processor is further configured to control the data server to execute steps of:
acquiring web identification information that identifies the web page on which the operation information is displayed;
storing the web identification information and associating the web identification information with the user identification information and the device identification information;
determining the device identification information associated with the acquired user identification information and the acquired web identification information; and
transmitting the operation signal to the image scanning device indicated by the determined device identification information.

5. The data server according to claim 1,
wherein the processor is further configured to control the data server to execute steps of:
generating the operation signal indicating one of a one-side scanning mode and a both-side scanning mode based on the operation of the operation information in the web page;
determining the image scanning device to which the operation signal is to be transmitted; and
transmitting the operation signal indicating one of the one-side scanning mode and the both-side scanning mode to the determined image scan device.

6. The data server according to claim 1,
wherein the processor is further configured to control the data server to execute steps of:
determining whether the acquired location information indicates a service providing device authorized to access the data server;
permitting access of the service providing device and execution of the determining step for determining the image scanning device to which the operation signal and the transmission step for transmitting the operation signal to the determined image scanning device via the network, when the acquired location information indicates a service providing device authorized to access the data server; and
restricting access of the service providing device and execution of the determining step for determining the image scanning device to which the operation signal and the transmission step for transmitting the operation signal to the determined image scanning device via the network, when the acquired location information indicates a service providing device not authorized to access the data server.

7. The data server according to claim 1,
wherein the processor is further configured to control the data server to execute steps of:
acquiring web identification information identifying the web page on which the operation information is displayed; and
deleting the scanned data stored in the memory after the service providing device acquires the scanned data stored in the memory, when the acquired web identification information indicates that the web page does not permit data saving.

8. The data server according to claim 1,
wherein the processor is further configured to control the data server to execute step of transmitting the scanned data stored in the memory to the service providing device indicated by the acquired location information.

9. The data server according to claim 1, wherein the data server is connected to an image scanning device configured to scan at least one paper set on the image scanning device.

10. A network system is configured to be connectable to a data server and an image scanning device configured to scan an image, the data server comprising:
a first processor having computer readable instructions stored thereon and configured to control the data server to execute the steps of:
acquiring location information indicating a location of a service providing device in the network system, wherein the service providing device is configured to be operated in the network system via a web page and the web page comprises operating information for instructing the image scanning device to execute a scanning process;
determining an image scanning device to which an operation signal for executing an image scanning process is transmitted in response to operation of the operating information in the web page;
transmitting the operation signal to the determined image scanning device via the network system to cause the determined image scanning device to execute an image scanning process;
storing scanned data obtained from the image scanning process of the determined image scanning device in a memory;
instructing the service providing device indicated by the acquired location information to acquire the scanned data stored in the memory,
wherein the image scanning device comprising:
a second processor having computer readable instructions stored thereon and configured to control the image scanning device to execute steps of:
receiving the operation signal;
executing the scanning process in response to receiving the operation signal; and
uploading the scanned data to the data server or the service providing device.

11. An upload method for a network system configured to be connectable to a data server, an image scanning device configured to scan an image, and a managing device that configured to receive a web page, the upload method comprising the steps of:
operating the image scanning device to execute a scanning process by operating operation information displayed on the web page received at the managing device in the network system;
acquiring location information indicating a location of a service providing device in the network system, wherein the service providing device is configured to be operated in the network system via the web page comprising the operating information;
determining an image scanning device to which an operation signal for executing the image scanning process is to be transmitted in response to operation of the operating information in the web page;
transmitting the operation signal from the data server to the determined image scanning device;
receiving the operation signal at the image scanning device;
executing the scanning process at the image scanning device in response to receiving the operation signal;
uploading scanned data from the image scanning device to the data server or the service providing device;
storing the scanned data in a memory at the data server; and
controlling the service providing device indicated by the acquired location information to acquire the scanned data stored in the memory at the data server.
